(19) United States
(12) Patent Application Publication
(10) Pub. No.: US 2023/0400655 A1
(43) Pub. Date: Dec. 14, 2023

(54) OPEN CASSETTE

(71) Applicant: Leviton Manufacturing Co., Inc., Melville, NY (US)

(72) Inventor: Charles Bragg, Bothell, WA (US)

(21) Appl. No.: 18/319,185

(22) Filed: May 17, 2023

Related U.S. Application Data
(60) Provisional application No. 63/350,109, filed on Jun. 8, 2022.

(51) Int. Cl. G02B 6/44

(52) U.S. Cl. CPC G02B 6/4453

(57) ABSTRACT

A fiber optic cassette has a design that eliminates the need for an enclosure or cavity in which to house optical fibers. This fiber optic cassette design can reduce material costs associated with manufacturing the cassette, and can reduce the size of the cassette's footprint while maintaining the ability to organize and interface optical fibers.

### CROSS-REFERENCE TO RELATED APPLICATION

This application claims priority to U.S. Provisional Application Ser. No. 63/350,109, filed on Jun. 8, 2022, and entitled “OPEN CASSETTE,” the entirety of which is incorporated by reference.

### TECHNICAL FIELD

The disclosed subject matter relates generally to fiber optic cassettes

### BACKGROUND

Fiber optic cables are often used as a medium fir telecommunication and computer networking due to their flexibility, high data capacity, and immunity to interference. Since light is used as the data transmission medium, fiber optic cables can carry data over long distances with little attenuation relative to electrical data transmission. Fiber optic cables are used in many types of applications, including local area networks that use optical transceivers, corporate intranets that deploy optical pathways for high-speed transmission of data on a corporate campus, or other such data transmission applications.

Fiber optic cassettes are often used to organize and manage fiber optic connections within telecommunication wiring enclosures. An example cassette-based system may include a fiber optic enclosure within which are installed one or more fiber optic trays, with one or more fiber optic cassettes mounted on each tray. These fiber optic cassettes typically house optical fibers within an enclosure or cavity defined by the cassette's walls, and include adapters mounted on their front edges on which the fibers are terminated.

The foregoing is merely intended to provide an overview of communication connector systems and is not intended to be exhaustive. Problems with the state of the art, and corresponding benefits of some of the various non-limiting embodiments described herein, may become further apparent upon review of the following detailed description.

### SUMMARY

The following presents a simplified summary of the disclosed subject matter in order to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

Various embodiments described herein provide a fiber optic cassette having a design that eliminates the need for an enclosure or cavity in which to house the fibers. This fiber optic cassette design can reduce material costs associated with manufacturing the cassette, as well as reduce the size of the cassette's footprint while maintaining the ability to organize and interface optical fibers.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the drawings. It will also be appreciated that the detailed description may include additional or alternative embodiments beyond those described in this summary.

### BRIEF DESCRIPTION OF DRAWINGS

FIG. 1 is a perspective view of an example chamber-less fiber optic cassette.

FIG. 2a is a perspective view of another example chamber-less fiber optic cassette.

FIG. 2b is a top view of the chamber-less fiber optic cassette.

FIG. 2c is a side view of the chamber-less fiber optic cassette.

FIG. 3 is a perspective view of the chamber-less fiber optic cassette with the flange removed.

FIG. 4 is a close-up view of the chamber-less fiber optic cassette with the flange removed.

FIG. 5 is a view of another example chamber-less fiber optic cassette.

FIG. 6 is a view of an example fiber optic rack that can be used to secure and organize multiple fiber optic cassettes.

FIG. 7 is a top view of the left side of a slidable shelf of the rack.

FIG. 8 is a view of a rear side of a front panel of the rack.

### DETAILED DESCRIPTION

The subject disclosure is now described with reference to the drawings wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

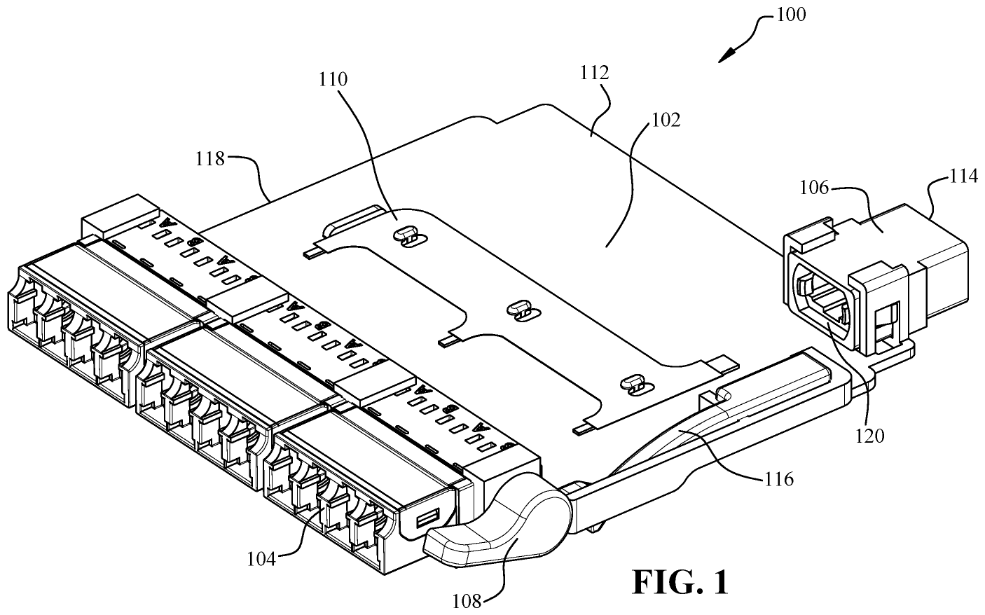

FIG. 1 is a perspective view of an example chamber-less fiber optic cassette 100 according to one or more embodiments. Fiber optic cassette 100 can have any suitable size according to the needs of a given fiber optic management application. For example, the width of fiber optic cassette 100 can correspond to the width of a cassette bay of a fiber optic tray (not shown) on which the fiber optic cassette 100 can be mounted, such as a fiber optic tray to be installed within a fiber optic enclosure or cabinet. For applications in which the fiber optic cassette 100 will be mounted directly in a fiber cabling cabinet (e.g., a high-density fiber cabling cabinet) the dimensions of fiber optic cassette 100 can correspond to those of a cassette bay of the cabinet.

The main body of the fiber optic cassette 100 comprises a plate 102 on which an organizational structure 110 is mounted or formed. The organizational structure 110 is configured to organize, route, or secure optical fibers. A rear adapter 106 is mounted on a rear edge 112 of the plate 102. A multifiber connector that terminates a fiber optic cable (not shown) can be plugged into rear-facing receptacle 114 of the rear adapter 106. Another multifiber connector that terminates a fiber optic pigtail (not shown) can be plugged into the front-facing receptacle 120 of the rear adapter 106, and individual fibers of the pigtail can be separated out, traversed along the surface of the plate 102, and terminated on the rear sides of fiber optic adapters 104 mounted on the front edge of the plate 102. The adapters 104 provide connectivity between the individual fibers terminated on the rear sides of the adapters 104 and other fibers (not shown) plugged into the front-facing receptacles of the adapters 104 using fiber optic connectors. The adapters 104 can be configured to accommodate substantially any type of fiber optic connector, including but not limited to Lucent connectors (LC), Subscriber Connector (SC), multi-fiber connectors (MPO, MTP), mini duplex connectors (MDC), or other types of fiber connectors.

The organizational structure 110 can be used to organize the optical fibers; e.g., by holding loops of excess fiber, by routing the fibers to their respective adapters 104, by maintaining separation between fibers, or by supporting the fibers in other ways. Organization structure 110 may also comprise one or more splice holder configured to hold fiber optic splices that connect ends of incoming optical fibers to ends of patching fibers.

In some embodiments, the fiber optic cassette 100 may also include an integrated latching mechanism 116 that locks the cassette 100 in place on a tray or other mounting surface as part of a multi-cassette assembly module. In the illustrated example, the latching mechanism 116 is configured to engage with an aperture on a mounting surface (not shown) such that, when the cassette 100 is fully installed and locked into position, the latching mechanism 116 prevents forward and rearward movement of the cassette 100. The latching mechanism 116 includes a front-facing release latch 108. Pressing the release latch 108 disengages the latching mechanism 116 from the aperture of the mounting surface, allowing the cassette 100 to be removed.

The plate 102 that makes up the main body of the cassette 100 includes no walls along its rear edge 112 or along one or more of its side edges 118, and thus does not define a chamber, enclosure, or cavity within which the optical fibers are housed. That is, the cassette 100 is designed to be chamber-less, such that the optical fibers rest on the top surface of the plate 102—or are secured in place by the organizational structure 110—without being housed or enclosed within a chamber or cavity. Moreover, the plate 102 does not interface with a top covering or lid that would, together with the plate 102, define an enclosed chamber.

In some embodiments, the optical fibers can be covered or protected by means that do not involve housing the fibers within a chamber or cavity. For example, after optical fibers have been routed from the rear adapter 106 to the adapters 104, at least a portion of the plate 102 can be wrapped with a heat-shrinkable material or another type of form-fit or snug-fitting material to protect the fibers from damage and to secure the excess fiber in place. In another example, at least a portion of the top surface of the plate 102 can be coated with an epoxy resin or another type of coating to protect and secure the fibers. Other chamber-less means for protecting the fibers are also within the scope of one or more embodiments.

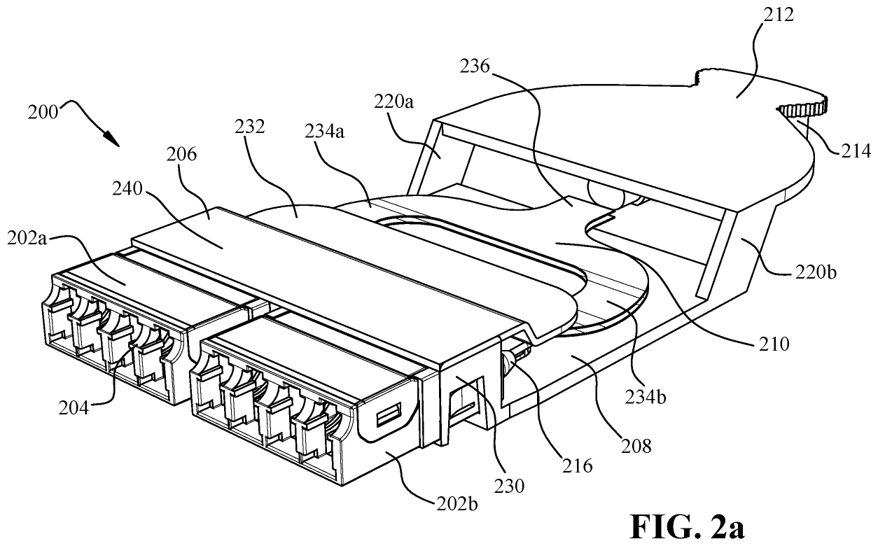

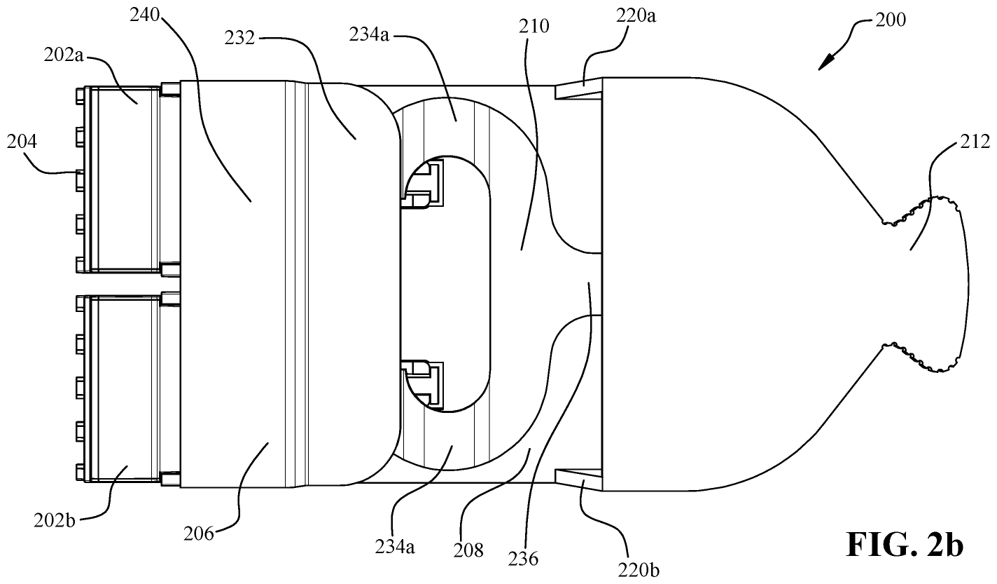

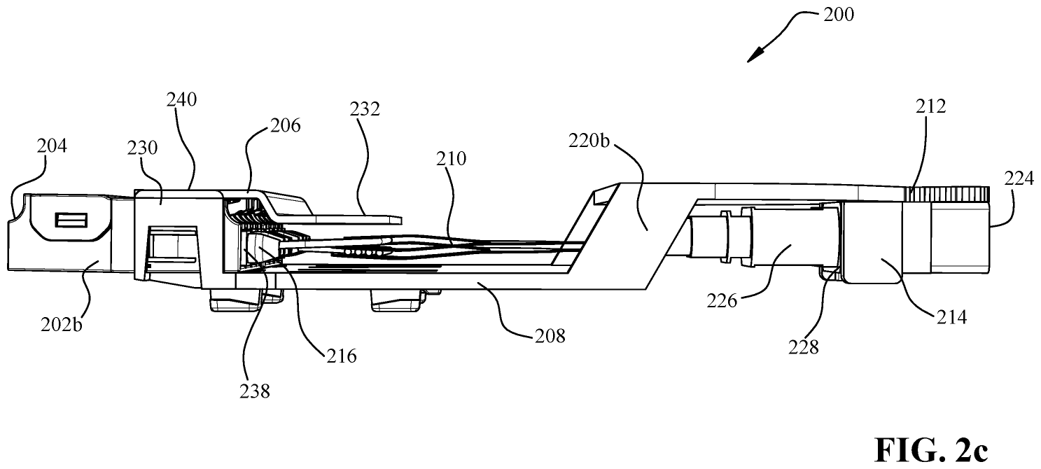

FIGS. 2a, 2b, and 2c are a perspective view, a top view, and a side view of another example chamber-less fiber optic cassette 200 according to one or more embodiments. Cassette 200 comprises a flat main plate 208 and a raised rear plate 212 attached to a rear end of the main plate 208 by two side arms 220a and 220b. The raised rear plate 212 is elevated relative to the main plate 208. A rear adapter 214 is attached to a bottom surface of the raised rear plate 212 (see FIG. 2c). A multifiber connector that terminates an incoming fiber optic cable (not shown) can be plugged into a rear-facing receptacle 224 of the rear adapter 214. Another multifiber connector 226 (see FIG. 2c) that terminates a fiber optic pigtail can be plugged into a front-facing receptacle 228 of the rear adapter 214. Routing of the optical fibers of the pigtail from the multifiber connector 226 to the front adapters 202 of the cassette 200 will be described in more detail below.

Adapter retainers 230 can be formed along the front edge of the main plate 208 of the cassette 200. These adapter retainers 230 are configured to receive and hold front adapters 202a and 202b. Each of the front adapters 202a and 202b comprises a row of front-facing adapter receptacles 204 that are each configured to receive a fiber optic connector that terminates an optical fiber (not shown). Corresponding rear-facing receptacles 238 of the front adapters 202a and 202b are configured to receive optical fiber connectors 216 (see FIG. 2c) that terminate the individual fibers of the fiber optic pigtail (that is, the fiber optic pigtail whose multifiber connector 226 is plugged into the front-facing receptacle 228 of the rear adapter 214). As in the example embodiment illustrated in FIG. 1, the adapters 202 can be configured to accommodate substantially any type of fiber optic connector, including but not limited to Lucent connectors (LC), Subscriber Connector (SC), multi-fiber connectors (MPO, MTP), mini duplex connectors (MDC), or other types of fiber connectors.

A flange 206 is configured to mount on a top of the adapter retainers 230, or otherwise mount to a front side of the chamber-less fiber optic cassette 200. The flange 206 comprises a base section 240 that mounts to the top of the adapter retainers 230 (or otherwise attaches to a front portion of the cassette 200) and an extended section 232 that extends toward a rear side of the cassette 200. While the flange 206 is mounted to the top of the adapter retainers 230, the extended section 232 is positioned above the fiber optic connectors 216 of the individual fibers of the pigtail. The flange 206 is a planar structure, lacking front, rear, or side walls (that is, the flange 206 has no walls on its front, rear, or side edges), and therefore does not enclose any of the fiber optic connectivity components within any type of chamber or enclosure. In some embodiments, as shown in FIG. 2c, the plane of the extended section 232 of the flange 206 can be lower than that of the base section 240, such that the flange 206 has a stepped-down profile.

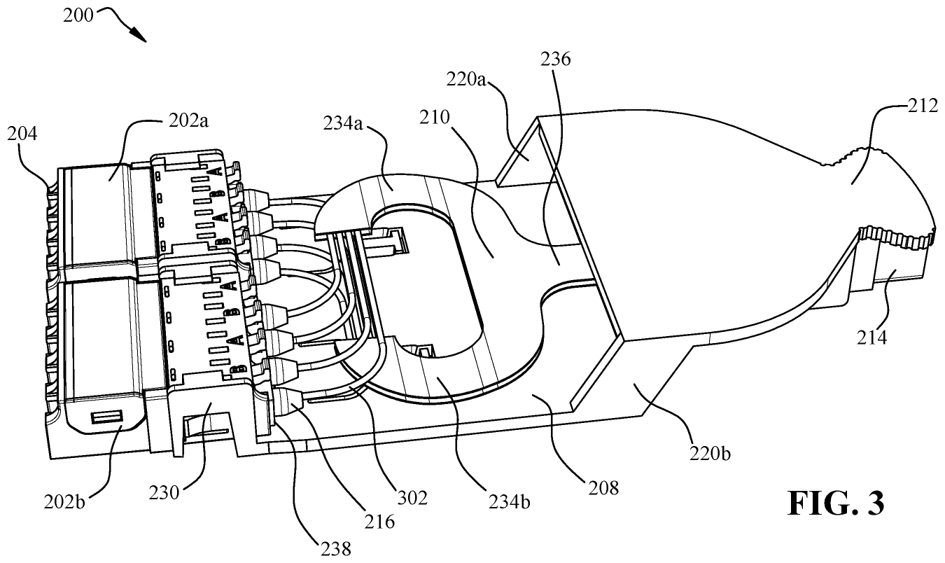

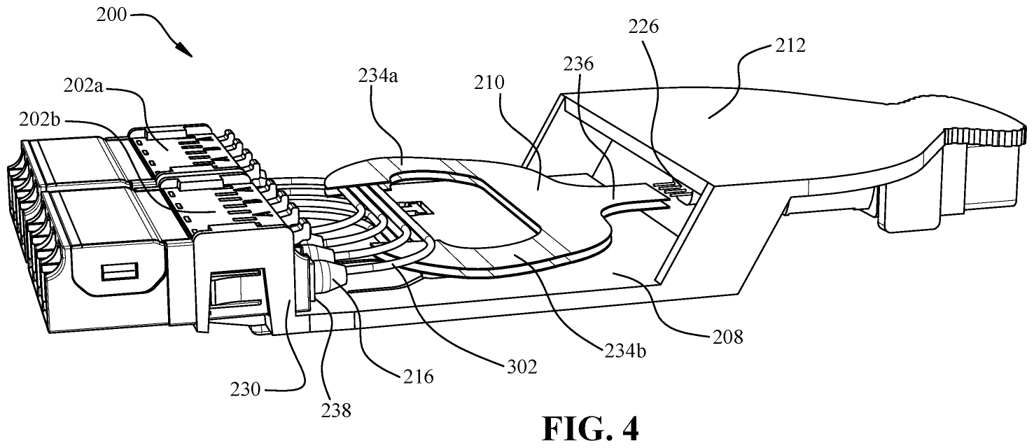

A flat sandwich assembly 210 is mounted to a top surface of the main plate 208 of the cassette between the raised rear plate 212 and the adapter retainers 230. The sandwich assembly 210 protects the individual fibers of the fiber optic pigtail that are routed from the multifiber connector 226 to the rear-facing receptacles 238 off the front adapters 202a, 202b. FIG. 3 is a perspective view of the fiber optic cassette 200 with the flange 206 removed, allowing the individual fibers 302 and their connections to the front adapters 202a, 202b to be viewed. FIG. 4 is a close-up view of the cassette 200 with the flange 206 removed, allowing the two layers of the sandwich assembly 210 to seen more clearly. Sandwich assembly 210 comprises two or more flat layers made of a suitable flexible material. The layers, and the sandwich assembly 210 as a whole, are C-shaped and comprise two curved arms 234a and 234b that arch in opposing directions and whose ends face one another across the main plate 208 in the width-wise direction. The layers, and the sandwich assembly 210, also comprise a tail section 236 that extends toward the rear side of the cassette 200 and faces the multifiber connector 226 plugged into the rear adapter 214. The sandwich assembly 210 is affixed to the top surface of the main plate 208 such that the plane of the sandwich assembly 210 is substantially parallel with the plane of the main plate 208.

The individual fibers 302 of the fiber optic pigtail terminated by the multifiber connector 226 are routed between the layers of the sandwich assembly 210 such that the fibers 302 enter the tail section 236 as a group and are evenly divided between the two curved arms 234a and 234b. In the example depicted in FIGS. 3 and 4, the pigtail comprises eight optical fibers 302, and therefore four optical fibers 302 are routed through each of the two curved arms 234a and 234b. Each optical fiber 302 exits the end of its corresponding curved arm 234a or 234b and is plugged into one of the rear-facing receptacles 238 of the front adapters 202a, 202b. The lengths of the curved arms 234a and 234b are such that a sufficient length of each optical fiber 302 is exposed to allow the optical fiber 302 to be easily manipulated during assembly; e.g., to plug the fiber's connector 216 into the rear-facing receptacle 324 of its corresponding front adapter 202a, 202b. When the flange 206 is mounted to the top of the adapter retainers 230 as shown in FIGS. 2a-2c, the extended section 232 of the flange 206 is positioned above the fiber connectors 216 and the exposed portions of optical fibers 302.

The layers of the sandwich assembly 210, as well as the portions of the optical fibers 302 that reside between the layers, can be held together using any suitable mechanism or material. In an example embodiment, the space between the two layers can be filled with an epoxy resin or another durable, heat-resistant material. The layers of the sandwich assembly 210 and the optical fibers 302 can also be bound together using shrink-wrap or a vacuum sealing technique.

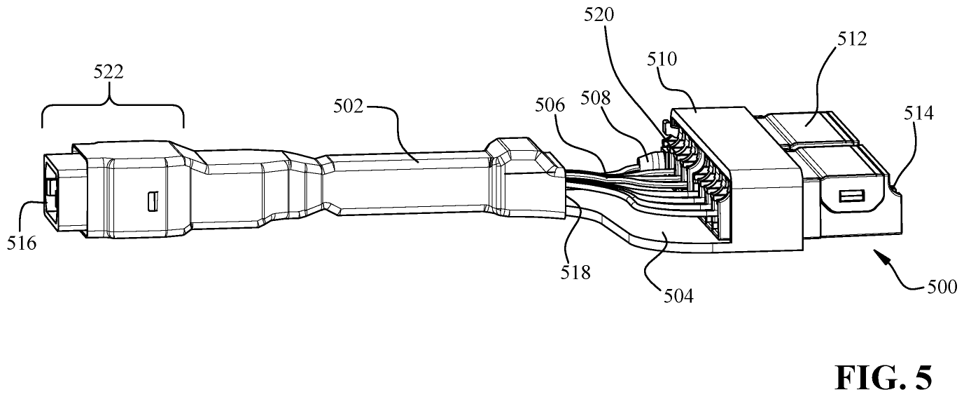

FIG. 5 is a view of another example chamber-less fiber optic cassette 200 according to one or more embodiments. Cassette 500 comprises a plate 504 that extends from an end of a hollow tail section 502. A rectangular bracket 510 is formed on the front edge of the plate 504 and is sized to hold fiber optic adapters 512, each of which comprises multiple front-facing adapter receptacles 514. Individual optical fibers 506 of a multifiber pigtail are terminated on rear-facing receptacles 520 of the adapters 512; e.g., by terminating each optical fiber 506 with a fiber optic connector 508 and plugging the connector into one of the rear-facing receptacles 520. The adapters 512 provide connectivity between the optical fibers 506 terminated on their rear-facing receptacles 520 and other optical fibers plugged into their front-facing receptacles 514. The segments of the optical fibers 506 that traverse between the tail section 502 and the adapters 512 are not enclosed within a chamber or housing.

From the rear-facing receptacles 514, the optical fibers 506 traverse across the plate 504 and enter an opening 518 at a front-facing end of the tail section 502. Inside the tail section 502, the optical fibers 506 connect to an adapter 522 (e.g., an MPO/MTP adapter) installed in the rear-facing end of the tail section 502. In some embodiments, the ends of the optical fibers 506 can be terminated to a multifiber plug (not visible in FIG. 5) that resides inside the tail section 502 and is plugged into a front-facing receptacle of the adapter 522. The rear-facing receptacle 516 of the adaptor is exposed through the rear end of the tail section 502. Another multifiber plug (not shown) of a multifiber cable can be plugged into the rear-facing receptacle 516 of the adapter 522 to interface the fibers of the multifiber cable with the optical fibers 506.

In some embodiments, the individual optical fibers 506 can traverse through a tube—e.g., a fully formed tube or an open partial tube, such as a ½ or ¾ tube or trough—that resides within the tail section 502 between the adapter 522 and the front opening 518 of the tail section 502. In other embodiments, portions of the optical fibers 506 within the tail section 502 can be wrapped with heat shrinkable material or another type of binding material.

Embodiments of the cover-less and chamber-less cassettes 100, 200, or 500 described herein are not limited to the designs depicted in FIGS. 1-5. Rather, any type of cover-less or chamber-less fiber optic cassette on which optical fibers can reside without being enclosed within a chamber, housing, or cavity is within the scope of one or more embodiments. The cassettes 100, 200, and 500 support optical fiber interfacing, organization, and retention using a simplified form factor that yields a small cassette footprint due to absence of a fiber chamber, enclosure, or housing.

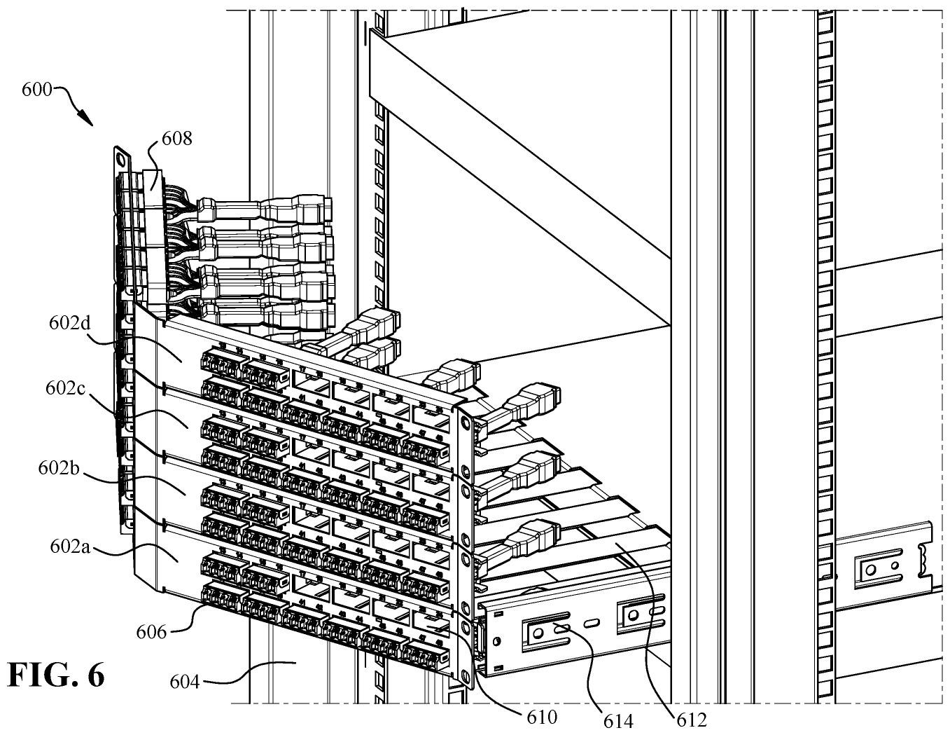

FIG. 6 is a view of an example fiber optic rack 600 that can be used to hold and organize multiple fiber optic cassettes 608. Some cassette-based racks comprise a fiber optic enclosure within which are installed one or more fiber optic trays with one or more fiber optic cassettes mounted on each tray. These trays can be slid out of the enclosure to allow access to the cassettes and slid back into the enclosure for containment during normal operation. In such systems, each cassette is typically mounted to an available space on the tray by sliding the cassette between two mounting rails formed on the tray, which hold the cassette in place on the tray. The tray is then slid into enclosure or rack using a suitable guiding mechanism (e.g., telescoping rails or guide channels). Each enclosure typically comprises multiple trays of cassettes, which are installed vertically within the rack in a stacked manner.

By contrast, rack 600 is designed to permit installation of, and access to, the fiber optic cassettes 608 without the need to install the cassettes 608 on fiber optic trays. Instead, the rack 600 comprises one or more slidable shelves, with each shelf comprising one or more vertical front panels 602 through which are cut rectangular openings 610 configured to retain the fiber optic cassettes 608. In the example depicted in FIG. 6, a shelf floor 612 is attached to a telescoping rail 614 mounted to an interior side surface (or vertical surface) of the rack 600, allowing the shelf floor 612 to slide into and out of the rack 600. A front panel 602a is mounted to the front edge of the shelf floor 612. This front panel 602a comprises a vertical wall with one or more openings 610 formed through the wall. In the example depicted in FIG. 6, the front panel 602a comprises two sections formed by bending the panel 602a in the middle of its length along the vertical axis, yielding distinct left and right sections whose planes face outward from the rack 600 at respective angles.

Multiple front panels 602 can be stacked on top of one another to allow more fiber optic cassettes 608 to be mounted on a single shelf. In the example depicted in FIG. 6, four front panels 602a-602d are stacked vertically on the shelf. Each front panel 602 comprises two rows of six openings 510 on each of its left and right sections.

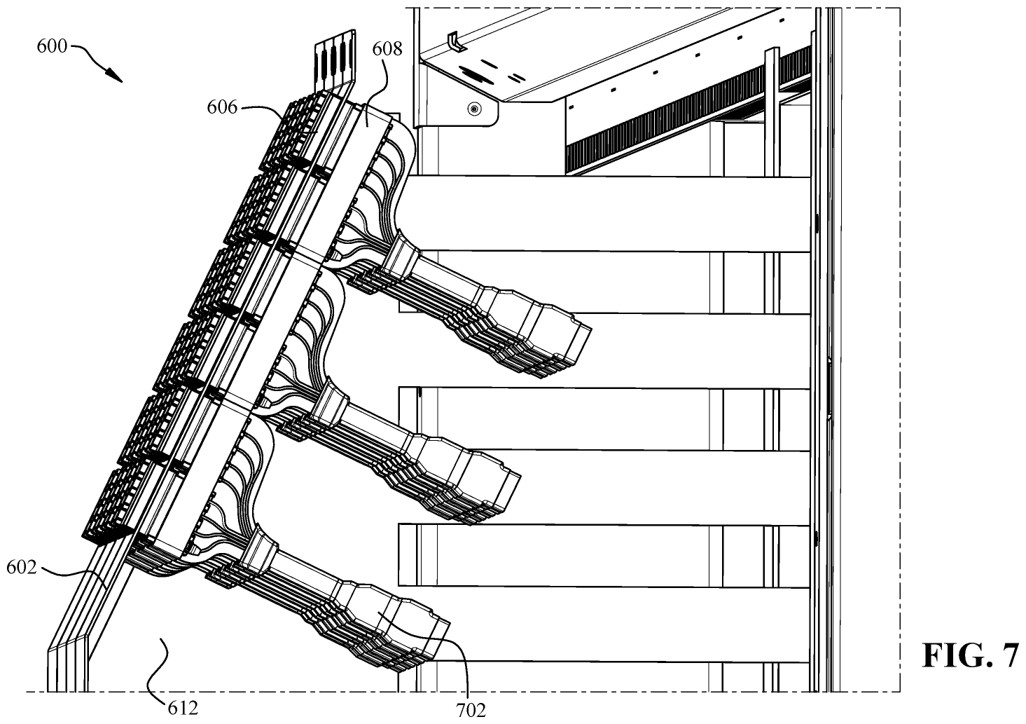

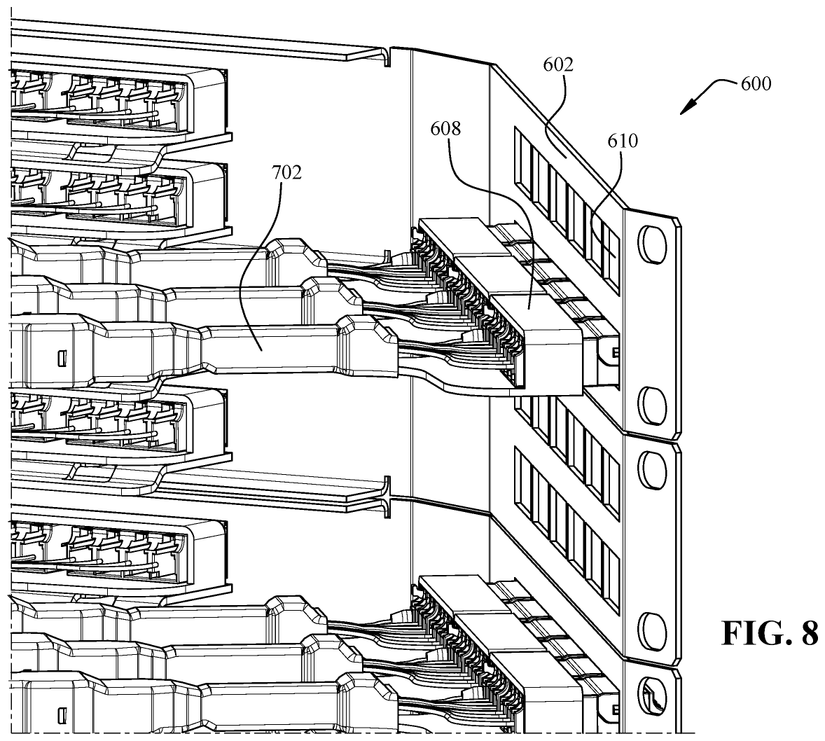

FIG. 7 is a top view of the left side of the slidable shelf of rack 600. FIG. 8 is a view of a rear side of a front panel 602 of the rack 600. The adapters 606 of each fiber optic cassette 608 can be installed through the openings 610 from the rear side of the front panels 602. The adapters 606 can be removably locked in place in the openings 610 using any suitable means, including but not limited to spring-loaded latching mechanisms affixed to the adapters 606 or brackets mounted to the adapters 606 on the outer side of the front panel 602. This configuration exposes the adapters 606 through the front of the rack 600, allowing individual fibers to be connected to the adapters 606 and thereby to the fibers of the cassette 608.

Embodiments of the rack 600 depicted in FIGS. 6-8 can hold and organize multiple fiber optic cassettes 608 within a fiber optic enclosure without the need to mount the cassettes 608 on the surface of a tray which is then itself installed in the rack. This rack configuration is suitable for use with substantially any type of fiber optic cassette, and is not limited to use with the chamber-less cassettes 100, 200, and 500 illustrated in FIGS. 1-5.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

What has been described above includes examples of systems and methods illustrative of the disclosed subject matter. It is, of course, not possible to describe every combination of components or methodologies here. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A fiber optic cassette, comprising:
a plate;
one or more fiber adapters located on a front edge of the plate and configured to hold ends of optical fibers; and
a cable adapter located on a rear edge of the plate.

2. The fiber optic cassette of claim 1, further comprising an organizational structure located on a surface of the plate and configured to at least one of retain, organize, or direct the optical fibers.

3. The fiber optic cassette of claim 1, wherein the fiber optic cassette is chamber-less.

4. The fiber optic cassette of claim 1, wherein ones of the optical fibers that are routed from the cable adapter to the one or more fiber adapters along a top surface of the plate are unenclosed.

5. The fiber optic cassette of claim 1, wherein the rear edge of the plate and one or more side edges of the plate comprises no walls.

6. The fiber optic cassette of claim 1, wherein the fiber adapters are at least one of Lucent connector (LC) adapters, subscriber connector (SC) adapters, multi-fiber connector adapters, or mini-duplex connector (MDC) adapters.

7. The fiber optic cassette of claim 1, further comprising a latching mechanism configured to releasably lock the fiber optic cassette in place on a fiber optic tray.

8. The fiber optic cassette of claim 1, wherein at least a portion of the plate and the one or more fiber adapters are wrapped with a form-fit material.

9. A fiber optic cassette, comprising:
a main plate;
fiber adapters located on a front edge of the main plate and configured to hold ends of optical fibers; and
a sandwich assembly comprising two similarly shaped layers and attached to a top surface of the main plate,
wherein the sandwich assembly is substantially flat and comprises two curved arms that arch in opposing directions,
ends of the two curved arms face one another across the main plate in a width-wise direction of the main plate, and
a first group of optical fibers and a second group of optical fibers of a multifiber cable are routed through the two curved arms, respectively, between the two layers.

10. The fiber optic cassette of claim 9, wherein the first group of optical fibers and the second group of optical fibers exit the ends of the two curved arms, respectively, and terminate on rear-facing receptacles of the fiber adapters.

11. The fiber optic cassette of claim 9, further comprising a raised rear plate that is attached to the main plate by two side arms and is elevated relative to the main plate.

12. The fiber optic cassette of claim 11, wherein a rear adapter is attached to a bottom surface of the raised rear plate and is configured to receive a multifiber connector that terminates the multifiber cable.

13. The fiber optic cassette of claim 9, further comprising a flange comprising a base section configured to mount on a front side of the fiber optic cassette and an extended section that extends toward a rear side of the fiber optic cassette.

14. The fiber optic cassette of claim 13, wherein while the base section is mounted on the front side of the fiber optic cassette, the extended section is positioned above the ends of the optical fibers held by the fiber adapters.

15. The fiber optic cassette of claim 13, wherein a front edge of the flange, a rear edge of the flange, and side edges of the flange comprise no walls.

16. The fiber optic assembly of claim 9, wherein a space between the two layers is filled with an epoxy resin.

17. The fiber optic assembly of claim 9, wherein the two layers are bound together by at least one of a vacuum-sealed material or shrink wrapping.

18. The fiber optic assembly of claim 9, wherein the fiber adapters are at least one of Lucent connector (LC) adapters, subscriber connector (SC) adapters, multi-fiber connector adapters, or mini-duplex connector (MDC) adapters.

19. A fiber optic cassette, comprising:
a cable adapter located on a rear side of the fiber optic cassette; and
one or more fiber adapters located on a front side of the fiber optic cassette and configured to hold ends of optical fibers routed from the cable adapter,
wherein the fiber optic cassette comprises no chamber, housing, or cavity within which the optical fibers are housed.

20. The fiber optic cassette of claim 18, further comprising a plate on which the cable adapter and the one or more fiber adapters are mounted.
